(19) United States
(12) Patent Application Publication
(10) Pub. No.: US 2015/0081649 A1
(43) Pub. Date: Mar. 19, 2015

(54) IN-LINE DEDUPLICATION FOR A NETWORK AND/OR STORAGE PLATFORM

(71) Applicant: LSI Corporation, San Jose, CA (US)

(72) Inventors: Seong-Hwan Kim, Allentown, PA (US); Dilip Ramachandran, San Jose, CA (US)

(73) Assignee: LSI Corporation, San Jose, CA (US)

(21) Appl. No.: 14/030,059

(22) Filed: Sep. 18, 2013

Related U.S. Application Data
(60) Provisional application No. 61/877,322, filed on Sep. 13, 2013.

(51) Int. Cl. G06F 17/30

(52) U.S. Cl. CPC G06F 17/30156
USPC 707/692

(57) ABSTRACT

An apparatus comprising a classification block, a pattern generator block, a hash key block and a replacement block. The classification block may be configured to (i) receive a data signal and (ii) identify a portion of the data signal that contains a duplicated data pattern. The pattern generation block may be configured to generate a common continuous pattern of data in response to the data signal. The hash key block may be configured to generate a hash key representing the duplicated data pattern. The replacement block may be configured to replace the duplicated data pattern with the hash key.

This application relates to U.S. Provisional Application No. 61/877,322, filed Sep. 13, 2013, which is hereby incorporated by reference in its entirety.

### FIELD OF THE INVENTION

The invention relates to networking generally and, more particularly, to a method and/or apparatus for implementing high efficient in-line deduplication for a network and/or storage platform.

### BACKGROUND

Deduplication (or dedup) is a technology that attempts to eliminate possible duplication of data in storage devices. By replacing common (or duplicated) data, deduplication saves on overall storage space needed to store data. Deduplication technology can improve storage system utilization. Conventional deduplication solutions use a dedicated ASIC (or general purpose CPU). Conventional approaches use a store and scan process, and result in large latency. Conventional deduplication implementations tend to be difficult to use in a dynamic networking environment. Unique chunks of data, or byte patterns, need to be stored during a process of analysis.

It would be desirable to implement in-line deduplication for a network and/or storage platform.

### SUMMARY

The invention concerns an apparatus comprising a classification block, a pattern generator block, a hash key block and a replacement block. The classification block may be configured to (i) receive a data signal and (ii) identify a portion of the data signal that contains a duplicated data pattern. The pattern generation block may be configured to generate a common continuous pattern of data in response to the data signal. The hash key block may be configured to generate a hash key representing the duplicated data pattern. The replacement block may be configured to replace the duplicated data pattern with the hash key.

### BRIEF DESCRIPTION OF THE FIGURES

Embodiments of the invention will be apparent from the following detailed description and the appended claims and drawings in which:

FIG. 1 is a block diagram of a data flow of the invention;

FIG. 2 is a diagram illustrating a context of the system;

FIG. 3 is a diagram of a processor used to implement the system; and

FIG. 4 is a context diagram of the invention.

### DETAILED DESCRIPTION OF THE EMBODIMENTS

Embodiments of the invention include providing a deduplication implementation that may (i) operate on a network and storage platform, (ii) provide in-line deduplication, (iii) be implemented at a data block level, (iv) use less memory space, (v) enable real time (or near) real time deduplication operations, (vi) be implemented between communication nodes to lower data bandwidth use in a link, and/or (vii) be useful for the latency sensitive and/or low bandwidth networks.

Embodiments of the invention may provide in-line deduplication processing using a communication processor. Examples of a communication processor may include a System on a Chip (SoC) hardware acceleration engine. Such a communication processor may include a classification engine, a crypto engine, a deep packet inspection engine, and/or a packet editor engine. The communications engine may be used to implement fast real time deduplication processing. If the deduplication process is deployed in a storage server environment, the process can lower the x86 processor load by offloading the deduplication processing. If the process is deployed in a networking environment, the process may provide real time (or near real time) deduplication services between two nodes of network. The process may be implemented using less memory space and/or may perform various data block level operations if the block size is large.

Emails often contain many duplicated patterns and/or often include duplicate email attachments. In an email server, there are possibly 10s or 100s of same attachment stored. Storing redundant data and/or attachments results in unnecessary storage space. With data deduplication, only one instance of the attachment is actually stored in the storage space (attached via PCIe interface). A communication processor processes/scans the incoming traffic. All the subsequent events will be replaced with a hash key found by a crypto engine in the communications processor. The invention can be used in between communication nodes to lower data bandwidth used in the link. It can add special value for the latency sensitive and/or low bandwidth network.

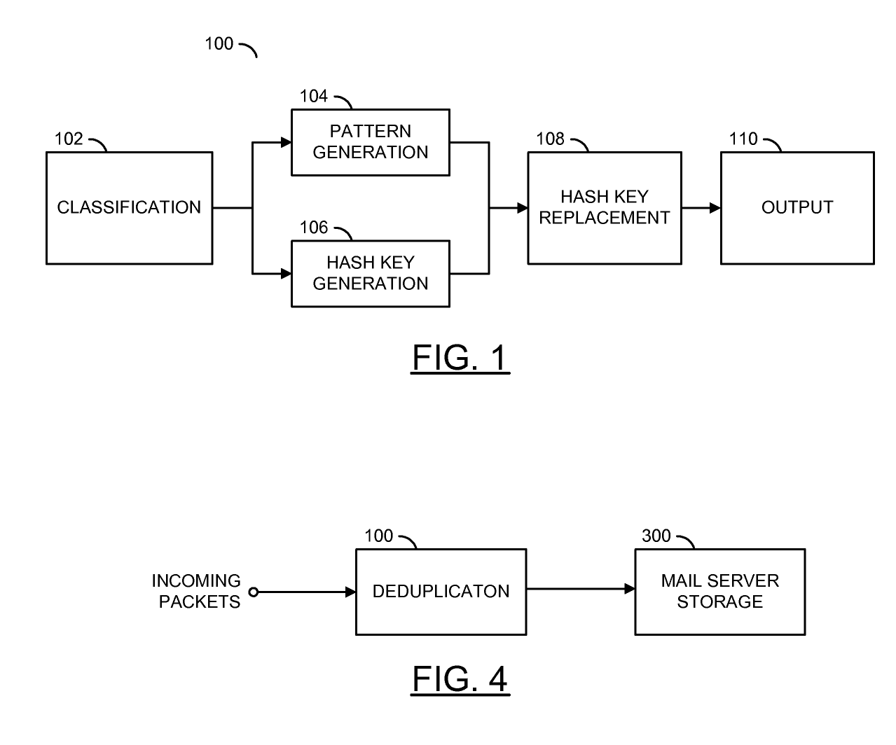

Referring to FIG. 1, a block diagram of a system 100 is shown illustrating a data flow in accordance with an embodiment of the invention. The system 100 generally comprises a block (or circuit) 102, a block (or circuit) 104, a block (or circuit) 106, a block (or circuit) 108, and a block (or circuit) 110. The circuit 102 may be implemented as a classification circuit. The circuit 104 may be implemented as a pattern generation circuit. The circuit 106 may be implemented as a hash key generation circuit. The circuit 108 may be implemented as a hash key replacement circuit. The circuit 110 may be implemented as an output circuit. The classification circuit 102 may identify traffic needed for deduplication. The circuit 102 may implement application recognition. For example, the circuit 102 may determine the source of a data string (e.g., email attachment, etc.). The circuit 104 may implement continuous pattern generation. The circuit 104 may operate on a CPU. The circuit 106 may implement hash key generation for the common patterns that may be implemented in a crypto processor/engine. The circuit 108 may replace patterns with the hash key. The circuit 110 may send deduplicated results to the storage or network interface.

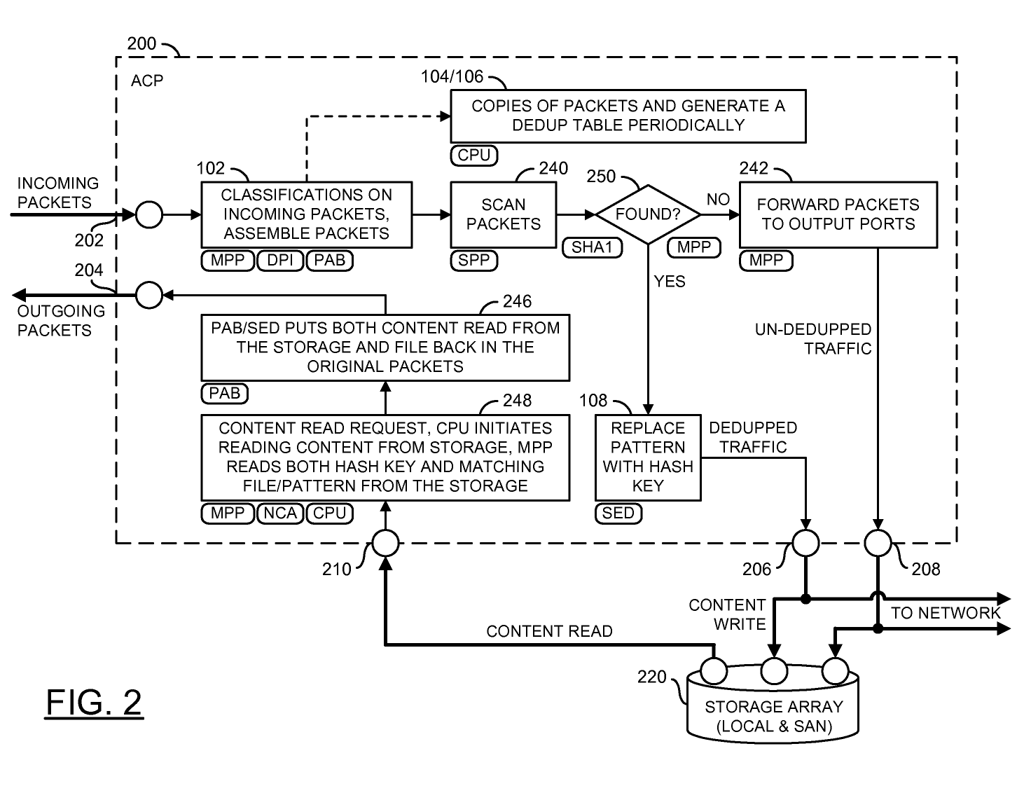

Referring to FIG. 2, a diagram illustrating an implementation of the present invention is shown. A processor 200 is shown having an input 202 that may receive incoming packets. An output 204 may transmit outgoing packets. An input/output 206 and an input/output 208 may be connected to a storage array 220 and/or a network. An input/output 210 may be connected to the storage array. The processor 200 shows the block 102, the block 104, the block 106 and the block 108. Additionally, the processor 200 generally comprises a block (or circuit) 240, a block (or circuit) 242, a block (or circuit) 246, and a block (or circuit) 248. A decision block 250 is also implemented. Each of the blocks shown may be implemented on a certain portion of the processor 200. The labels shown include a central processing unit (CPU), a modular packet processor (MPP) or classification engine, a deep packet inspection engine (DPI) (or REGEX engine), a packet assembly block (PAB), a security protocol process engine (SPP), a secure hash algorithm (SHA1), a network CPU adapter (NCA), and a stream editor engine (SED). These labels refer to various portions of a processor that may implement the functions described. The block 240 may scan each of the incoming packets. The block 242 may forward a packet request to the output ports. The MPP may read from both the hash key and matching file pattern from the external storage 220. The block 246 may place original content intended for the external storage 220 and/or for original file back into the packets. The block 248 may provide a content request where the CPU initiates reading content from the storage array 220.

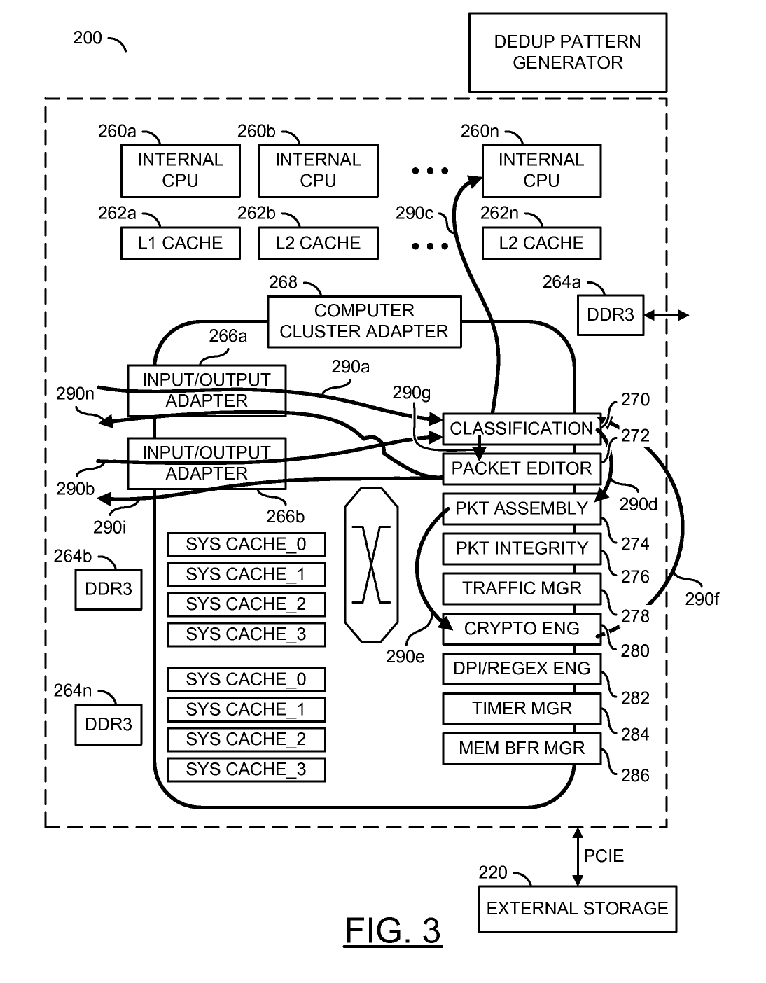

Referring to FIG. 3, a more detailed example of the processor 200 is shown. The processor 200 may be implemented as a multi-core processor. A number of internal central processing units 260a-260n are shown. A number of cache circuits 262a-262n are shown. A number of memory circuits 264a-264n are shown. In one example, the memory circuits 264a-264n may be implemented as DDR3 type memory. However, the particular type of memory implemented may be varied to meet the design criteria of a particular implementation. A number of input/output adapters 266a-266b are shown. A computer cluster adapter 268 is shown. The processor 200 also includes a classification block (or circuit) 270, a packet editor block (or circuit) 272, a packet assembly block (or circuit) 274, a packet integrity block (or circuit) 276, a traffic manager block (or circuit) 278, a crypto (or SSP engine) engine block (or circuit) 280, a DPI/REGEX engine block (or circuit) 282, a timer manager block (or circuit) 284 and a memory buffer manager block (or circuit) 286.

The processor 200 is shown connected to the external storage 220. In one example, the connection from the processor 200 to the external storage 220 may be a PCIE bus. However, the particular type of bus implemented may be varied to meet the design criteria of a particular implementation.

In FIG. 3, number of data paths are shown as lines 290a-290i. A path from either one or both of the input/output adapters 266a-266b to the classification engine 270 is shown by a line 290a and a line 290b. A path implemented from the classification engine 270 to one of the internal CPUs 260a-260n (to provide a copy of the packets) is shown by a line 290c. Another path from the classification engine 270 to the packet assembly engine 274 (for packet assembly) is shown by a line 290d. A path from the packet assembly engine 274 to the crypto engine 280 (for generating the hash key) is shown by a line 290e. A path from the crypto engine 280 to the classification engine 270 (for detecting hash key match) is shown by a line 290f. A path from the classification engine 270 to the packet editor engine 272 (for removing the common pattern and/or filling in hash key) is shown by a line 290g. Paths from the packet editor 272 to the input/output adapter 266a and to the input/output editor 266d are shown by the lines 290h and 290i. In one example, a fast path ingress pre-processing process may be implemented.

The classifier circuit 272 (MPP) and/or the DPI engine 282 may be used to decide whether the flow needs deduplication or not, depending on the application. An example of a target application is email. If deduplication is needed, then the MPP circuit 270 sends copies of the packets to one of the internal CPUs 260a-260n (where the original stream of packets still flows) to identify a common pattern/file. A hierarchy of likelihood of duplication may be generated. In the case of email, the classifier circuit 272 (MPP) and/or the DPI/REGEX engine circuit 282 check whether the email has an attachment or not. If there is/are attachments, deduplication may be performed on one or more selected attributes first.

The MPP circuit 270 and/or the packet assembly (PAB) circuit 274 then assemble the packets until a maximum deduplication size is completed (e.g., 16 KB, 64 KB). If the file size is beyond 64 KB, then the deduplication process will be fragmented to the maximum PAB addressable sizes (e.g., 64 KB). However, the particular size of the maximum PAB may be varied to meet the design criteria of a particular implementation. Setting a maximum addressable size of the packet assembly circuit (PAB) 274 may improve latency issues in a network deduplication operation since the processor 200 does not have to store the entire file and/or process deduplication. The SPP (or crypto) engine 280 may be used to generate a hash key using the SHA1 processor.

In another example, a fast path egress process may be implemented. If a matching hash key is found in the MPP (or classification) block 270, then the SED engine (or packet editor) 272 replaces the matching pattern (or file) with the hash key (e.g., the deduplication operation). For a reverse deduplication operation, the SED engine 272 will replace the hash key with the original file which is stored in the memory or storage device.

In another example, one or more of the internal CPUs 260a-260n ingress progress may be implemented. The deduplication pattern search application normally runs on one of the CPUs 260a-260n and extracts common patterns/files from the stream of packets and/or generates hash keys for the common pattern. One of the internal CPUs 260a-260n monitors incoming traffic and runs search processes to find common patterns. The search process may be a frequency based process, but does not have to be limited to a single process. From this monitoring, the one of the CPUs 260a-260n will generate a dictionary with the hash key for each original file/pattern. One of the internal CPUs 260a-260n sends the common pattern or file (obtained from the search process) to memory/storage, and programs an MPP/classification tree with the hash keys.

In another example, a post ingress processing may be implemented. All of the incoming packets may be assembled in the packet assembly circuit 274. The assembly packets may be forwarded to the SPP/crypto engine 280. The SPP/crypto engine 280 may run the SHA1 process, and/or may generate a hash key. The hash key may be sent back to the MPP/classification circuit 270. The MPP/classification circuit 270 may run a tree look-up. If there is a matching hash key, then it is an already known file/pattern.

Referring to FIG. 4, a context diagram of the invention is shown. The circuit 100 is shown providing deduplication. A mail server storage block (or circuit) 300 is shown. The mail server storage block may efficiently store data without duplicated data from attachments and/or text. While a mail server application is shown, other deduplication applications may implement the circuit 100.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

An example of the processor 200 may be found in application Ser. No. 12/975,823, filed Dec. 22, 2010; Ser. No. 12/976,045, filed Dec. 22, 2010; Ser. No. 13/405,053 filed Feb. 23, 2012; and/or Ser. No. 13/232,422 filed Sep. 11, 2011, the appropriate portions of which are incorporated by reference. However, other multi-core processors may me implemented.

While the invention has been particularly shown and described with reference to embodiments thereof, it will be understood by those skilled in the art that various changes in form and details may be made without departing from the scope of the invention.

1. An apparatus comprising:
a classification block configured to (i) receive a data signal and (ii) identify a portion of the data signal that contains a duplicated data pattern;
a pattern generation block configured to generate a continuous pattern of data in response to said data signal;
a hash key block configured to generate a hash key representing said duplicated data pattern; and
a replacement block configured to replace said duplicated data pattern with the hash key.

2. The apparatus according to claim 1, wherein said hash key block generates a plurality of said hash keys each corresponding to a respective one of a plurality of said duplicated data patterns.

3. The apparatus according to claim 2, wherein said replacement block replaces each of said respective duplicated data patterns with a respective hash key.

4. The apparatus according to claim 1, wherein said duplicated data pattern comprises a file.

5. The apparatus according to claim 4, wherein said file comprises an email attachment.

6. The apparatus according to claim 1, wherein said duplicated data comprises text in an email.

7. The apparatus according to claim 1, wherein said apparatus is implemented using a multi-core processor.

8. The apparatus according to claim 1, wherein said apparatus is implemented in a storage platform.

9. The apparatus according to claim 1, wherein said apparatus is implemented in a network environment.

10. The apparatus according to claim 1, wherein said apparatus provides in-line deduplication.

11. The apparatus according to claim 1, wherein said apparatus provides real time deduplication operations.

12. A method for processing data, comprising the steps of:
(A) receiving a stream of data containing duplicated data strings;
(B) identifying one or more of said duplicated data strings;
(C) assigning a hash key to each of said duplicated data strings; and
(D) storing said hash key and said duplicated data strings in a memory.

13. The method according to claim 12, wherein said method determines whether deduplication is needed prior to performing steps (A)-(D).

14. The method according to claim 12, wherein said method selects a portion of data for processing based on a hierarchy of likelihood of duplication.

15. The method according to claim 12, further comprising the step of:
replacing said hash key with said duplicated data strings during a reverse deduplication process.
